(19) United States
(12) Patent Application Publication
(10) Pub. No.: US 2020/0282788 A1
(43) Pub. Date: Sep. 10, 2020

(54) VEHICLE INTEGRAL BUSHING REAR SUSPENSION SYSTEMS

(71) Applicant: Ford Global Technologies, LLC, Dearborn, MI (US)

(72) Inventors: Friedrich Peter Wolf-Monheim, Aachen (DE); Timothy Drotar, Commerce Township, MI (US); Ralf Hintzen, Aachen (DE); Daniel Mainz, Herzogenrath (DE); Paul Zandbergen, Wurselen (DE); Steve Scott Allen, Saline, MI (US)

(21) Appl. No.: 16/810,528

(22) Filed: Mar. 5, 2020

(30) Foreign Application Priority Data
Mar. 5, 2019 (DE) 102019202910.8

(51) Int. Cl. B60G 13/00; B60G 3/20; B60G 7/02; B62D 21/11

(52) U.S. Cl. CPC B60G 13/003; B60G 3/202; B60G 2200/34; B62D 21/11; B60G 2204/41; B60G 7/02

(57) ABSTRACT

Vehicle integral bushing rear suspension systems are disclosed. An example rear wheel suspension includes a wheel carrier configured to mount a wheel of a vehicle, the wheel rotatable about a rotational axis, a lower transverse control arm coupled to the wheel carrier below the rotational axis, the lower transverse control arm including a first joint to be disposed on a vehicle structure and a second joint to be disposed on the vehicle structure, the second joint displaced from the first joint along a longitudinal axis, a camber transverse control arm coupled to the wheel carrier above the rotational axis, and a track transverse control arm coupled to the wheel carrier in front of the rotational axis, wherein the lower transverse control arm, the camber transverse control arm and the track transverse control arm couple the wheel carrier to the vehicle structure.

### RELATED APPLICATION

This patent claims priority to German patent application no. 102019202910.8, which was filed on Mar. 5, 2019, and was entitled “Hinterradaufhängung.” German patent application no. 102019202910.8 is hereby incorporated herein by reference in its entirety.

### FIELD OF THE DISCLOSURE

This disclosure relates generally to vehicle suspensions, and, more particularly, to vehicle integral bushing rear suspension systems.

### BACKGROUND

A vehicle suspension includes a tire, a spring, and a damper, such as a shock absorber or a strut. A variety of different suspension configurations for vehicles are known. For example, an independent suspension system allows each wheel on an axle to translate vertical relative to the other. Rigid axle suspension systems include a rigid beam coupling the wheels of an axle and, in some examples, are used in the rear axles of utility vehicles.

### SUMMARY

An example rear wheel suspension disclosed herein includes a wheel carrier configured to mount a wheel of a vehicle, the wheel rotatable about a rotational axis, a lower transverse control arm coupled to the wheel carrier below the rotational axis, the lower transverse control arm including a first joint to be disposed on a vehicle structure and a second joint to be disposed on the vehicle structure, the second joint displaced from the first joint along a longitudinal axis, a camber transverse control arm coupled to the wheel carrier above the rotational axis, and a track transverse control arm coupled to the wheel carrier in front of the rotational axis, wherein the lower transverse control arm, the camber transverse control arm and the track transverse control arm couple the wheel carrier to the vehicle structure.

An example vehicle disclosed herein includes a wheel, a vehicle structure, and a rear wheel suspension including a wheel carrier coupled the wheel, the wheel rotatable about a rotational axis, a lower transverse control arm coupled to the wheel carrier below the rotational axis, the lower transverse control arm including a first joint disposed on a vehicle structure and a second joint disposed on the vehicle structure, the second joint displaced from the first joint along a longitudinal axis, a camber transverse control arm coupled to the wheel carrier above the rotational axis, and a track transverse control arm coupled to the wheel carrier in front of the rotational axis, lower transverse control arm, the camber transverse control arm and the track transverse control arm coupling the wheel carrier to the vehicle structure.

### BRIEF DESCRIPTION OF THE DRAWINGS

FIG. 1 illustrates a front view of an example rear wheel suspension implemented on an example motor vehicle and constructed in accordance with the teachings of this disclosure.

FIG. 2 illustrates a top view of the example rear wheel suspension of FIG. 1.

FIG. 3 illustrates a side view of the example rear wheel suspension of FIGS. 1 and 2.

FIG. 4 illustrates a first isometric view of the rear wheel suspension of FIGS. 1-3.

FIG. 5 illustrates a second isometric view of the rear wheel suspension of FIGS. 1-4.

The figures are not to scale. Instead, the thickness of the layers or regions may be enlarged in the drawings. In general, the same reference numbers will be used throughout the drawing(s) and accompanying written description to refer to the same or like parts. Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

For independent suspension systems, a wheel carrier, on which a respective vehicle wheel can be rotatably coupled, is connected via several control arms to the body and/or frame of the vehicle. The movement of the vehicle wheel is decoupled from that of the body and/or frame of the vehicle because the control arms are pivotable connected to both the vehicle structure (e.g., the body and/or frame, etc.) and to the wheel carrier. In some examples, hinged connections are implemented via pivot bearings or via ball joints. In some examples, the bearings are elastic and/or complaint to reduce the transmission of vibrations to the vehicle structure from the wheel carrier and to enable a certain degree of flexibility about a pivot axis of the bearing.

An independent suspension system must provide adequate stiffness (e.g., rigidity, etc.) with respect to rotations of the wheel carrier about the X-axis (e.g., camber stiffness, etc.), Y-axis (e.g., caster stiffness, etc.) and Z-axis (e.g., track stiffness, etc.) of the vehicle. As used herein, the X-axis corresponds to a longitudinal axis of the motor vehicle, the Y-axis corresponds to an axis that is transverse to the motor vehicle (e.g., perpendicular to the longitudinal axis, etc.), and the Z-axis corresponds to an axis that is perpendicular to the X and Y axes (e.g., the Z axis may be the vertical axis). Other design considerations of independent suspension systems include minimizing the weight, the complexity and the manufacturing costs of the system. Independent suspensions systems are also designed to reduce the transmission of vibrations from the wheel to the vehicle structure.

The examples disclosed herein include a low cost, low complexity and efficient independent rear wheel suspension. Additionally, the examples disclosed herein reduce vibrations transmitted between the wheels and the vehicle.

Disclosed herein are example rear wheel suspensions for a wheel that is rotatable about a rotational axis. The examples disclosed herein can be implemented on any suitable type of motor vehicle, such as a heavy goods vehicle (HGV), a pick-up truck and/or a passenger car. Examples disclosed herein can also be implemented on a non-motor vehicle, such as trailers and semitrailers. The example rear wheel suspension system includes a wheel that is rotatable about a wheel rotational axis. In some examples disclosed herein, the wheel coupled to the suspension system is an engine-driven wheel. In such examples disclosed herein, the rear wheel suspension includes components of a drivetrain of the vehicle and/or can be formed to receive components of the drivetrain. In some examples disclosed herein, the rear wheel suspension system can include and/or receive a drive shaft, and/or a differential transmission an electric motor.

In some examples disclosed herein, the rear wheel suspension system includes a wheel carrier that is connected to a vehicle structure via a lower transverse control arm hinged below the wheel rotational axis, a camber transverse control arm hinged above the wheel rotational axis and a track transverse control arm hinged in front of the wheel rotational axis. As used herein, the terms “in front of” and “behind” relate to the position in relation to the X-axis, (e.g., along the longitudinal axis of the vehicle, etc.) such that the term “in front of” designates a position closer to the front of the vehicle and “behind” a position closer to the rear of the vehicle. In some examples disclosed herein, the track transverse control arm is hinged in front of the wheel rotational axis with respect to the X-axis (e.g., closer to the front of the vehicle, etc.) In some examples disclosed herein, the track transverse control arm is hinged in front of the wheel rotational axis relative to the direction of travel.

In some examples disclosed herein, the wheel can be coupled to the wheel carrier via a hub/bearing unit. In such examples, the wheel rotational axis is stationary with respect to the wheel carrier, while the wheel carrier is movable with respect to the vehicle body and/or frame. The term vehicle structure refers to all the parts of the vehicle that are assigned to the sprung mass of the vehicle (e.g., a chassis, a vehicle body, an auxiliary frame, etc.) In some examples disclosed herein, the wheel carrier is coupled to the vehicle structure via three transverse control arms, the camber transverse control arm, track transverse control arm and lower transverse control arm. The control arms and the wheel carrier can be composed of metal (e.g., cast iron, aluminum or steel sheet, etc.), composites (e.g., glass fiber reinforced polymer (GFRP), carbon fiber reinforced polymer (CFRP), etc.) and/or any other suitable material.

In some examples disclosed herein, the rear wheel suspension system includes a spring and a shock absorber that are arranged between the wheel carrier and the vehicle structure. In such examples, the spring and the shock absorber are coupled directly to the wheel carrier and/or on one of the transverse control arms (e.g., the lower transverse control arm, etc.) and/or be supported thereon.

In some examples disclosed herein, the transverse control arms are hinged on the wheel carrier side (e.g., connected movably to the wheel carrier, etc.) and hinged on the vehicle structure (e.g., connected movably to the vehicle structure, etc.). As used herein, the joints coupled to the wheel carrier are referred to as “outer joints” and the joints coupled to the structure are referred to as “inner joints.” In some examples, some or all of the joints can be implemented as bearings. In some examples, the joints can be implemented as pivot joints (e.g., pivot bearings, etc.), each of which has one degree of freedom or as a ball joint, which has three degrees of freedom. In some examples disclosed herein, the joint is implemented as an elastic joint (e.g., the respective joint has at least one rubber-elastic, complaint, or elastomeric element which enables to a certain extent displacements and/or rotations of the control arm relative to the vehicle structure or the wheel carrier, etc.). In some examples, some or all elastic joints can be pressed into a recess of the control arm, the wheel carrier, and/or in the vehicle structure. In some examples disclosed herein, the elasticity of the joint opens additional degrees of freedom of the joint, which removes potential overdetermination and the transmission of vibrations arising at the wheel to the vehicle structure. In some examples disclosed herein, the elastic joint and/or bearing generates pre-tensioning which improves the dynamics of the rear wheel suspension.

In some examples disclosed herein, the lower transverse control arm is hinged below the wheel rotational axis on the wheel carrier (e.g., the corresponding external joint is arranged below the wheel rotational axis in relation to the vertical axis of the vehicle (Z-axis), etc.). In some examples disclosed herein, the camber transverse control arm is hinged above the wheel rotational axis on the wheel carrier, (e.g., the corresponding external joint is arranged above the wheel rotational axis in relation to the vertical axis of the vehicle, etc.). In such examples, the lower transverse control arm and the camber transverse control arm are hinged offset to one another in the Z-direction. In some examples disclosed herein, the size and geometry of the camber transverse control arm and the position of its internal and external joints have a significant influence on the camber of the wheel and changes thereof during operation of the suspension assembly. In some examples, the track control arm is hinged in front of the wheel rotational axis on the wheel carrier in relation to the longitudinal axis of the vehicle (e.g., X-axis, etc.). In such examples, the corresponding external joint is offset towards the front of the vehicle in relation to the wheel rotational axis in the X-direction. In some examples, the track transverse control arm is hinged in front of at least one of the two other control arms on the wheel carrier. In such examples, the camber transverse control arm and/or the lower transverse control arm can be hinged behind the wheel rotational axis on the wheel carrier. Alternatively, at least one of these two control arms can be hinged at the height of the wheel rotational axis in relation to the X-axis. In some examples, the size and geometry of the track transverse control arm and the position of its internal and external joints influences how the track of the wheel changes during compression.

In some examples disclosed herein, the lower transverse control arm is connected by two lower internal joints to the vehicle body spaced apart along the X-axis and transmits forces between the wheel carrier and the vehicle structure acting along X-axis. That is, the lower transverse control arm is not hinged via a single internal joint, but rather via two lower internal joints on the vehicle body that are spaced apart in the longitudinal direction of the vehicle. In some examples, the lower transverse control arm does not react torques about the Z-axis and about the Y-axis. In such examples, the lower transverse control arm transmits forces acting along the X-axis (e.g., forces transmitted along the longitudinal direction of the vehicle, etc.). In some examples, the camber transverse control arm and/or the track control arm can also transmit forces along the x-axis between the wheel carrier and the vehicle structure. In some examples, the stabilization of the lower transverse control arm about the Z-axis increases the track stiffness of the suspension system and the stabilization about the Y-axis the lower transverse control arm improves the caster stiffness of the suspension system.

In some examples disclosed herein, the rear wheel suspension has a comparatively simple structure compared to prior art suspension systems and only includes three transverse control arms. In some examples disclosed herein, the track and camber or the changes thereof during compression can be set in each case by adjustment of the track transverse control arm or the camber transverse control arm.

In some examples disclosed herein, the lower transverse control arm has the two lower internal joints (e.g., as a front lower internal joint and rear lower internal joint, etc.) which are offset relative to one another in the longitudinal direction of the vehicle. The lower internal joints can be pivot joints, such that the pivot axes of the joints are not parallel to each other. In some examples, one or both of the internal joints can be pre-tensioned (e.g., the joint or the bearing is formed to be elastic, etc.). In such examples, the pre-tensioning of the internal joint(s) is generated to improve the dynamics of the rear wheel suspension. In some examples disclosed herein, the pre-tensioning of the front lower internal joint is minimized. In such examples, the tension of the front lower internal joint is configured to be soft (e.g., low stiffness, etc.) and the rear lower internal joint is configured to be stiff (e.g., high stiffness, etc.). In such examples, the configuration of the internal joints increases the stiffness in the Y-direction (e.g., transverse stiffness, etc.) and the stiffness in the Z-direction (e.g., camber stiffness, etc.), decreases the stiffness in the X-direction (e.g., track stiffness, etc.) and improves transverse dynamic driving performance and driving comfort.

In some examples disclosed herein, the camber transverse control arm, the track control arm and/or the lower transverse control arm can be connected to a subframe of the vehicle (e.g., an auxiliary frame of the vehicle, etc.). In such examples, the subframe is coupled to a frame (e.g., chassis, etc.) of the vehicle. In some examples disclosed herein, the subframe is connected to vehicle frame via an elastic coupling (e.g., via one or more elastic bushings, etc.). In such examples, the elastic coupling reduces the vibrations transmitted between the wheel(s) and the vehicle body. In some examples, the subframe can have any suitable configuration or shape (e.g., composed of one of more cast metal parts or sheet metal parts coupled via a suitable connection techniques such as welding, riveting, screwing, composed of a single piece, etc.).

In some examples disclosed herein, the lower transverse control arm is connected to the wheel carrier by two lower external joints spaced apart from each other along the X-axis. The lower external joints of the lower transverse arm can be arranged flush along the X-axis and can define a pivot axis parallel to the X-axis. In other examples, the lower external joints can be spaced apart in the Y-direction and/or in the Z-direction, such that the eternal joint(s) define a pivot axis at an angle relative to the X-axis. In such examples, the position of the lower external joints prevents rotation of the wheel carrier with respect to the lower transverse control arm. In some examples disclosed herein, the lower external joints can be coupled together by a joint axis (e.g., formed by a threaded bolt, etc.). In some examples disclosed herein, the rear wheel suspension system includes a single lower external joint, which extends along the X-axis. In some examples disclosed herein, the region between the two lower external joints can be entirely or partially enclosed by the lower transverse control arm and/or by the wheel carrier. In some examples disclosed herein, the enclosure of the region between the external joints protects the suspension assembly from dirt, moisture and extreme temperatures. In some examples disclosed herein, the region is not enclosed, which reduces weight and the space requirements of the rear wheel suspension.

In some examples disclosed herein, the lower transverse control arm has shell design and includes an upper shell and a lower shell. In some examples disclosed herein, the upper shell and/or lower shell can be composed of multiple parts and/or can be manufactured as one piece. In some examples, the upper and lower shells are sheet metal parts. In other examples, the shells can be composed of a composite (e.g., fiber-reinforced plastic, etc.). In some examples, the upper shell and the lower shell are coupled together by any suitable means (e.g., fasteners, welding, and/or gluing, etc.). In some examples disclosed herein, the shell design of the lower transverse control arm increases the torsional stiffness of the lower transverse control arm in relation to the Y-axis and the overall caster stiffness of the rear wheel suspension. In other examples, the lower transverse control arm can be manufactured in one piece. In such examples, the lower transverse control arm can be composed of metal (cast iron, aluminum or the like) and/or a composite.

In some examples disclosed herein, the distance between the lower internal joints of the lower transverse control arm is at least 100 mm, (e.g., 120 mm, 150 mm, etc.). In such examples, the rotation of the lower transverse control arm with respect to the vehicle structure is minimized to improve stabilization of the wheel carrier and increases the track and caster stiffness of the suspension system.

In some examples disclosed herein, a first connection line (e.g., a first axis, etc.) defined by a camber transverse control arm internal joint of the camber transverse control arm on the vehicle structure and a camber transverse control arm external joint of the camber transverse control arm on the wheel carrier. In some examples disclosed herein, the first connection line is inclined with respect to the Y-Z-plane and the rotational axis of the wheel by between −45° and +45 (e.g., between −20° and +20°, at least ±2°, at least ±5°, at least ±10°, etc.). In other examples, the angles of inclination defined by the joints of camber transverse control arm are greater than ±45°. In some examples disclosed herein, the camber transverse control arm internal joint couples the camber transverse control arm to the vehicle structure. In some examples disclosed herein, the camber transverse control arm is connected to the wheel carrier via the camber transverse control arm external joint. The connection line between the two stated joints can be inclined as described with respect to the Y-Z-plane (e.g., the axis defined by the Y-axis and the Z-axis, etc.) towards the rear of the suspension assembly (e.g., along the x-axis, etc.) to compensate for a pre-tensioning of the front lower internal joint. In some examples disclosed herein, the camber transverse control arm external joint is offset to the rear (e.g., along the x-axis, etc.) with respect to the camber transverse control arm internal joint.

In some examples disclosed herein, the rear wheel suspension system includes at least one spring (e.g., a coil spring, etc.). Additionally or alternatively, the rear wheel suspension system can include other types of springs (e.g., a pneumatic spring, etc.). In such examples, the spring can also function as a shock absorber. In some examples disclosed herein, a force action line (e.g., a center line, etc.) of the spring extends parallel to the Z-axis. In other examples, the force action line is inclined with respect to the Z-axis. In such examples, the force action line can be inclined to the rear with respect to the Y-Z-plane (e.g., the force action line is inclined toward the X-axis as viewed from bottom to top, etc.). Alternatively or additionally, the force action line can be inclined inwardly with respect to the X-Z-plane. In some examples disclosed herein, the inclination of the spring can compensate for the pre-tensioning of the front lower internal joint of the lower transverse control arm. In some examples disclosed herein, the spring is retained by upper and lower retaining elements (e.g., spring seats which can be arranged on the vehicle structure and on the wheel carrier and/or on one of the control arms, etc.). For example, the lower retaining element can be disposed on the lower transverse control arm. In some examples disclosed herein, the corresponding retaining elements can be inclined to support the corresponding inclination of the coil spring.

In some examples disclosed herein, the external joint of the track transverse control arm on the wheel carrier is offset along the Z-axis by at most 70 mm with respect to the wheel rotational axis. For example, the track transverse control arm external joint, by which the track transverse control arm is connected in a hinged manner to the wheel carrier, is arranged along the Z-axis approximately at the height of the wheel rotational axis. The external joint of the track transverse control arm can be offset upwards (in the positive Z-direction) or downward (in the negative Z-direction). In some examples disclosed herein, the offset of track transverse control arm external joint improves the track stiffness and the camber stiffness of the rear wheel suspension assembly.

In some examples disclosed herein, a second connection line (e.g., a second axis) is defined by an internal joint of the track transverse control arm on the vehicle structure and external joint of the track transverse control arm. In such examples, the second connection line is inclined by less than ±20°, with respect to the X-Y-plane (e.g., greater than 10°, etc.). The internal joint of track transverse control arm is a hinged joint that couples the track transverse control arm to the vehicle structure. In some examples, the second connection line extends within the X-Y-plane (e.g., the plane defined by the X-axis and the Y-axis, etc.) and/or can be inclined with respect to X-Y plane (e.g., less than ±20°, greater than ±10°, etc.). In some examples, the second connection can be inclined upward (in the positive Z-direction) or downward (in the negative Z-direction). In some examples, the orientation of the second connection line can change based on the current wheel load. In some examples disclosed herein, descriptions of the orientation of the second connection line are described with reference to the normal load condition of the vehicle (e.g., a state in which the vehicle is not under load or only under insignificant load and no dynamic loading or relief of load of the wheel as a result of an uneven road surface is provided, etc.).

In some examples disclosed herein, the camber transverse control arm is disposed in front of the wheel rotational axis in the X-direction and at least partially above the wheel rotational axis in the Z-direction. For example, the coil spring can be arranged in front of the wheel rotational axis in the X-direction and the camber transverse control arm can be arranged in the X-direction between the coil spring and the wheel rotational axis. In some examples disclosed herein, the positions of the wheel rotational axis can, in the case of a driven axle, correspond to the profile of the drive shaft. In some examples, the drive shaft is inclined with respect to the wheel rotational axis. Additionally or alternatively, the camber transverse control arm can be disposed (e.g., partially, fully, etc.) along the X-axis at the height of the wheel rotational axis (e.g., arranged partially vertically above the wheel rotational axis, parallel to the wheel rotational axis, at an angle to wheel rotational axis, etc.). In some examples disclosed herein, the camber transverse control arm intersects with the wheel rotational axis in the X-Y-plane. In other examples disclosed herein, the camber transverse control arm is arranged behind the wheel rotational axis. For example, the above-mentioned shock absorber can be disposed behind the wheel rotational axis in the X-direction and the camber transverse control arm can be disposed between the wheel rotational axis and the shock absorber or behind the shock absorber.

In some examples disclosed herein, to restrict the rolling movement of the vehicle, the rear wheel suspension system includes a stabilizer which, in the event of uneven compression, transmits forces from the wheel suspension on one side of the vehicle to the wheel suspension on the opposite side. In some examples disclosed herein, the stabilizer is coupled to the lower transverse control arm via a control rod. In such examples, the coupling rod is connected by a coupling rod joint to the lower transverse control arm and is arranged adjacent to a third connection line (e.g., a third axis, etc.) between a rear lower external joint and a rear lower internal joint of the lower transverse control arm (e.g., the coupling rod extends outward from the stabilizer along or at inclination relative to the Z-axis and is connected to the stabilizer and to the lower transverse control arm via the coupling rod joint, etc.). The coupling rod joint can be elastic or inelastic. The rear lower external joint couples the lower transverse control arm to the wheel carrier and the rear lower internal joint couples the lower transverse control arm to the vehicle structure. In some examples, the effectiveness of the stabilizer is improved if the coupling rod joint is arranged either on the connection line between these joints or adjacent to this connection line (e.g., 30 mm offset, 20 mm offset, etc.). In such examples, the mass of the lower transverse control arm is comparatively reduced. In some examples, the structural connection path between the rear lower external joint and the rear lower internal joint (e.g., a connection path corresponding to the third connection line, etc.) is stiff. In some examples disclosed herein, the forces transmitted via the coupling rod into the lower transverse control arm in the immediate vicinity of the third connection line are transmitted to the lower transverse control arm. In some examples disclosed herein, the rear lower external joint and the rear lower internal joint are stiff in order to generate a rigid overall structure of the rear wheel suspension in the Y-direction, which increases the efficiency of the stabilizer system because the forces introduced via the coupling rods into the lower transverse control arm can be transmitted effectively into the wheel carrier.

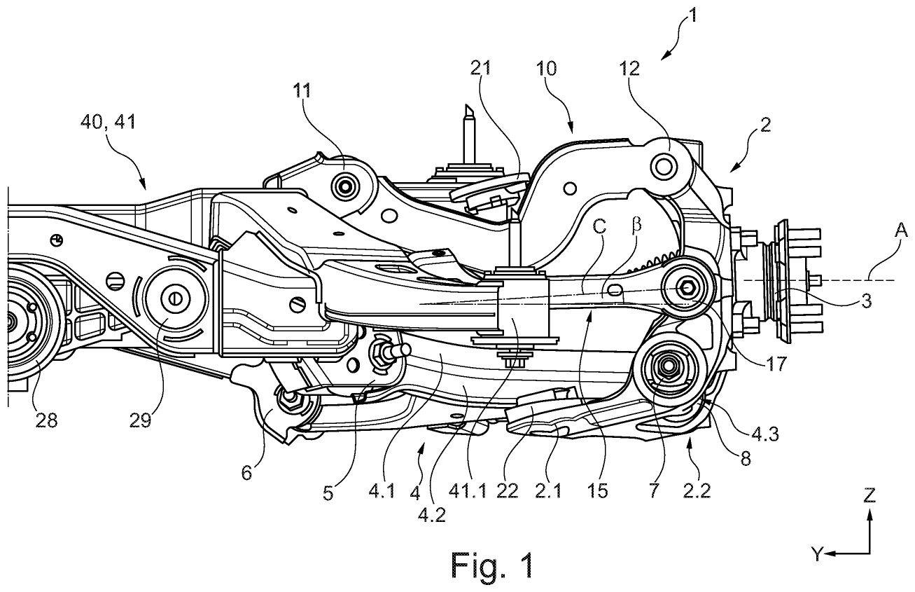

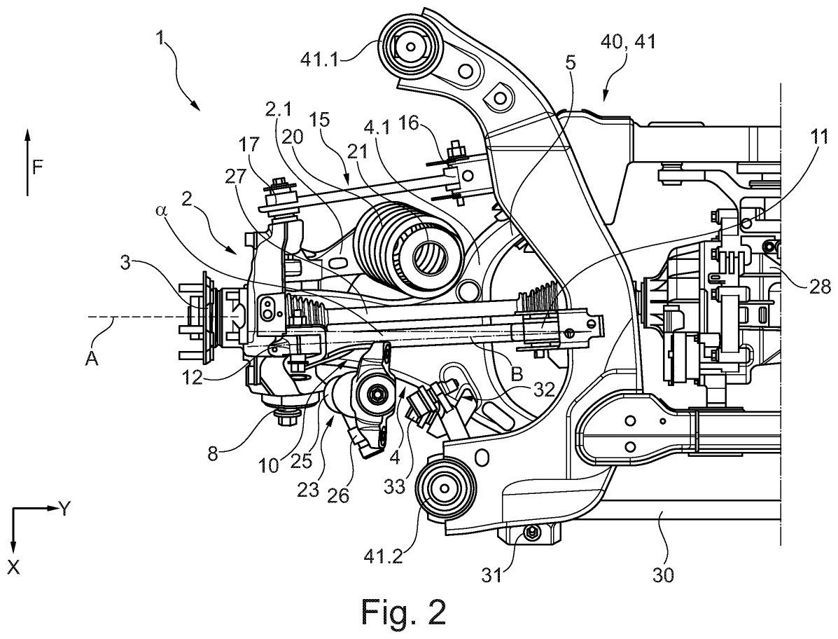

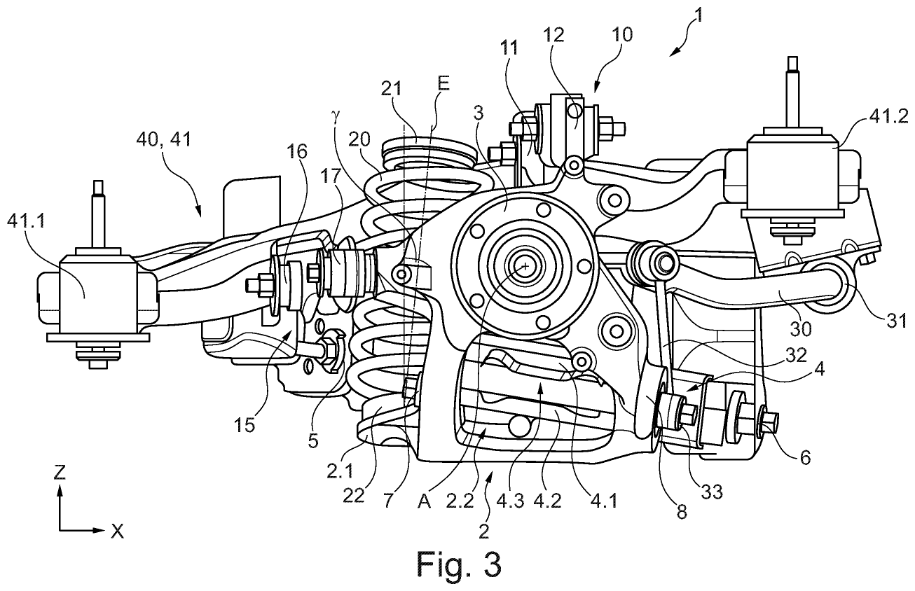

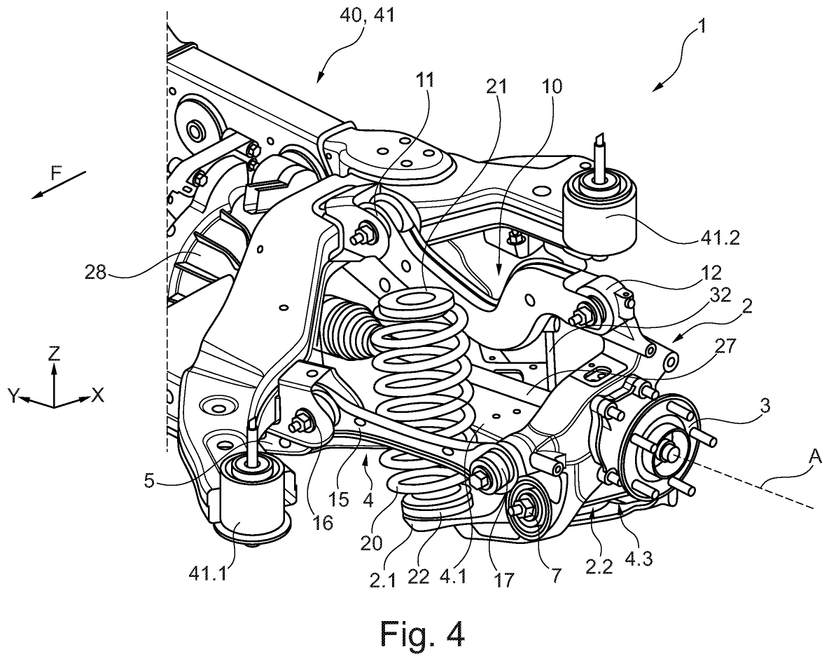

FIGS. 1-5 illustrate an example rear wheel suspension 1 implementing the teachings of this disclosure, for example, for a car or HGV. A wheel (not illustrated) is received via an example hub/bearing unit 3 on an example wheel carrier 2 which can be composed of a metal (e.g., cast iron, aluminum, etc.). An example wheel rotational axis (A) of the wheel is defined by the hub/bearing unit 3. The wheel carrier 2 is connected to an example auxiliary frame 41 by an example lower transverse control arm 4, an example camber transverse control arm 10 and an example track transverse control arm 15. In the illustrated examples of FIGS. 1-5, the auxiliary frame 41 includes example sleeve portions 41.1 in which rubber bushings are received via which a connection to the chassis (not illustrated) of the vehicle is provided. The chassis and auxiliary frame 41 are parts of an example vehicle structure 40. The rubber bushings isolate the auxiliary frame 41 from the rest of the vehicle structure 40 to reduce the transmission of vibrations from the wheel to vehicle structure 40.

In the illustrated examples of FIGS. 1-5, the example lower transverse cross arm 4 is coupled to the auxiliary frame 41 by an example front lower internal joint 5 and an example rear lower internal joint 6. The front lower internal joint 5 and the rear lower internal joint 6 are pressed into the lower transverse cross arm 4. In the illustrated examples of FIGS. 1-5, the lower transverse cross arm 4 is coupled to the wheel carrier 2 by an example front lower external joint 7 and an example rear lower external joint 8. The front lower external joint 7 and the rear lower external joint 8 are pressed into wheel carrier 2.

In the illustrated examples of FIGS. 1-5, the lower internal joints 5, 6 are spaced apart (e.g., displaced from) from one another along the X-axis In order to maximize the caster stiffness of the rear wheel suspension 1, the distance between the lower internal joints 5, 6 is relatively long (e.g., greater than 150 mm, etc.). In the illustrated examples of FIGS. 1-5, the front lower internal joint 5 is not pre-tensioned. In the illustrated examples of FIGS. 1-5, the lower transverse control arm 4 has a shell design with an example upper shell 4.1 and an example lower shell 4.2. In some examples, the shell design has a high torsional stiffness in relation to the Y-axis and increases the caster stiffness of the rear wheel suspension 1. In the illustrated examples of FIGS. 1-5, the lower external joints 7, 8 are coupled to the lower transverse control arm 4 via a screw that is received in an example tubular structure 4.3 between the shells 4.1, 4.2. The example structure 4.3 is disposed in an example region 2.2 of the wheel carrier 2. In the illustrated example of FIGS. 1-5, the region 2.2 is not enclosed. In other examples, the region 2.2 can be enclosed to protect lower external joints 7, 8 from dirt, moisture and temperature fluctuations.

In the illustrated examples of FIGS. 1-5, the example camber transverse control arm 10 is coupled to the auxiliary frame 41 by an example camber transverse control arm internal joint 11, which is pressed into the camber transverse control arm 10 and/or into the wheel carrier 2. In the illustrated examples of FIGS. 1-5, the example camber transverse control arm 10 is also coupled by an example camber transverse control arm external joint 12 pressed into the camber transverse control arm 10 and/or into the wheel carrier 2. The camber transverse control arm external joint 12 is offset forward with respect to the camber transverse control arm internal joint 11 in relation to the X-axis (e.g., offset forward in a direction of travel F, etc.) such that an example first connection line (B) from the camber transverse control arm internal joint 11 to the camber transverse control arm external joint 12 is inclined with respect to the Y-Z-plane by a first angle of inclination (a). In the illustrated example of FIGS. 1-5, the first angle is −10° (corresponding to an inclination to the rear). In other examples, the first angle of inclination (a) can have any suitable value (e.g., be between +45° and −45°, etc.)

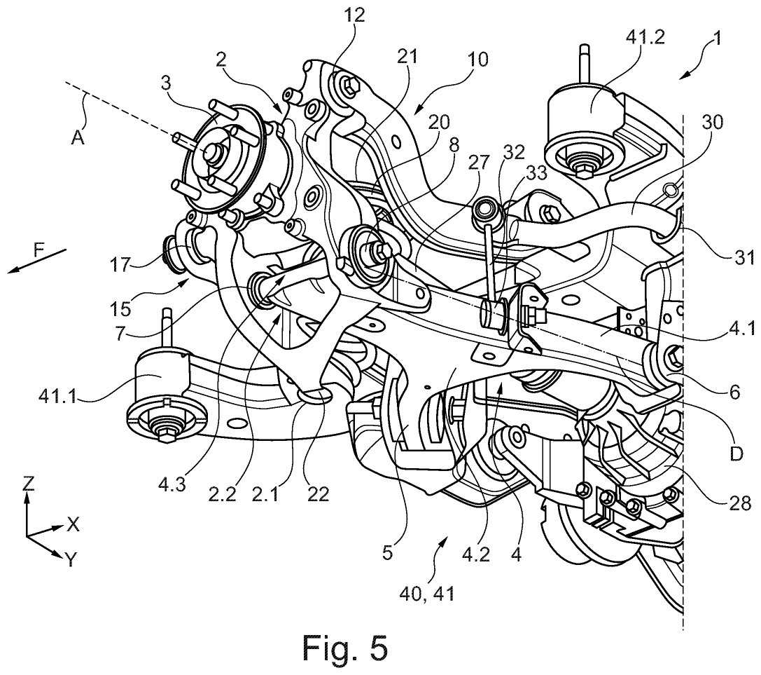

The example track transverse control arm 15 is connected to the auxiliary frame 41 by an example track transverse control arm internal joint 16 pressed into the track transverse control arm 15 and to the wheel carrier 2 by an example track transverse control arm external joint 17, which is pressed into the track transverse control arm 15 and/or into the wheel carrier 2. To facilitate the adjustability of the track stiffness and the camber stiffness, the track transverse control arm external joint 17 is disposed in the vertical direction approximately at the height of wheel rotational axis (A). In the illustrated example of FIGS. 1-5, the height offset of the transverse control arm external joint 17 is 5 millimeters. In other examples, the height offset of the transverse control arm external joint 17 can have any suitable values (e.g., 50 mm, −50 mm, etc.). In the illustrated example of FIGS. 1-5, the rear wheel suspension system is unloaded and a second connection line C defined by the track transverse control arm internal joint 16 and the track transverse control arm external joint 17 is inclined by a second angle of inclination B with respect to the X-Y-plane. In the illustrated example of FIG. 5, the second angle of inclination B is 10°. In other examples, the second angle of inclination B of can be any suitable angle (e.g., between −20° and +20°, etc.).

The joints 5, 6, 7, 8 11, 12, 15, 16, 17 between transverse cross arms 4, 10, 15 and wheel carrier 2 and/or the auxiliary frame 41 can be elastic rotary joints, ball joints, or a combination thereof. In the illustrated example of FIG. 5, the joints 5, 6, 7, 8 11, 12, 15, 16, 17 are pressed into transverse cross arms 4, 10, 15 and/or into wheel carrier 2. In some examples, the joints 5, 6, 7, 8 11, 12, 15, 16, 17 are connected to wheel carrier 2 and/or auxiliary frame 41 by fasteners (e.g., screws, nuts, etc.).

In the illustrated example of FIG. 5, an example coil spring 20 is disposed between the example wheel carrier 2 and the example vehicle structure 40. The example elastic spring beds 21, 22 isolate the coil spring 20 from the wheel carrier 2 and/or the vehicle structure 40. The example spring bed 22 is supported by an example bearing portion 2.1 of wheel carrier 2. In some examples, to compensate for the above-mentioned pre-tensioning of front lower internal joint 5, an example force action line E (e.g., the center line of the spring, etc.) of the coil spring 20 is inclined to the rear by an example third angle of inclination y with respect to the Y-Z-plane. In some examples, the force action line E is additionally inclined inward with respect to the X-Z-plane. In some examples, the bearing portion 2.1 is inclined to correspond to the inclination of the coil spring 20

An example shock absorber 23 is disposed between the wheel carrier 2 and the vehicle structure 40. In other examples, the shock absorber 23 can be supported on one of the control arms 4, 10, 15 (e.g., the lower transverse control arm 4, etc.). In the illustrated examples of FIGS. 1-5, a connection of the shock absorber 23 to the wheel carrier 2 improves the efficacy of the shock absorber 23. In other examples, a connection of the shock absorber 23 to lower transverse control arm 4 reduces the space requirement of the shock absorber 23 in the vertical direction. On the upper side of the shock absorber 23, the shock absorber 23 is hinged on vehicle structure 40 (not illustrated). On the underside of the shock absorber 23, the shock absorber 23 is connected by an example connection element 25 to the wheel carrier 2. In some examples, an example valve unit 26 can be connected to shock absorber 23 to facilitate adjusting the damping of the shock absorber 23.

In the illustrated examples of FIGS. 1-5, the camber transverse control arm 10 is arranged along the X-axis behind wheel rotational axis (A) and between the wheel rotational axis and shock absorber 23 arranged further to the rear of the vehicle. In other examples, the camber transverse control arm 10 can be arranged behind the shock absorber 23. In other examples, the camber transverse control arm 10 can be disposed in front of wheel rotational axis A and/or between coil spring 20 and wheel rotational axis A. The camber transverse control arm 10 can be disposed (e.g., partially disposed,) along the X-axis at the vertical height of wheel rotational axis A. In such examples, the camber transverse control arm 10 can extend parallel to wheel rotational axis A or at an angle relative to the wheel rotational axis A.

An example drive shaft 27 is, for the purpose of the transmission of force, disposed between the hub/bearing unit 3 and an example rear drive unit 28. In some examples, the rear drive unit 28 can have a differential transmission which is connected via a cardan shaft to a front motor. Alternatively or additionally, the rear drive unit can include its own motor (e.g., an electric motor, etc.). The rear drive unit 28 is fitted on the auxiliary frame 41 with the aid of the bearing elements 29.

An example stabilizer 30 is connected by example stabilizer joints 31 to the auxiliary frame 41 and is coupled to the example lower transverse control arm 4 by example coupling rods 32. In the illustrated example of FIGS. 1-5, an example coupling rod joint 33 is formed as a pivot joint and is disposed adjacent to an example third connection line D from the rear lower internal joint 6 to the rear lower external joint 8. In such examples, the efficiency of the stabilizer 30 is improved and the weight of lower transverse control arm 4 is improved.

Example methods, apparatus, systems, and articles of manufacture for vehicle integral bushing rear suspension systems are disclosed herein. Further examples and combinations thereof include the following: Example 1 includes a rear wheel suspension comprising a wheel carrier configured to mount a wheel of a vehicle, the wheel rotatable about a rotational axis, a lower transverse control arm coupled to the wheel carrier below the rotational axis, the lower transverse control arm including a first joint to be disposed on a vehicle structure and a second joint to be disposed on the vehicle structure, the second joint displaced from the first joint along a longitudinal axis, a camber transverse control arm coupled to the wheel carrier above the rotational axis, and a track transverse control arm coupled to the wheel carrier in front of the rotational axis, wherein the lower transverse control arm, the camber transverse control arm and the track transverse control arm couple the wheel carrier to the vehicle structure.

Example 2 includes the rear wheel suspension of example 1, wherein the lower transverse control arm is coupled to the wheel carrier via a third joint and a fourth joint, the fourth joint displaced from the third joint along the longitudinal axis.

Example 3 includes the rear wheel suspension of example 1, wherein the lower transverse control arm includes an upper shell and a lower shell.

Example 4 includes the rear wheel suspension of example 1, wherein the camber transverse control arm includes a fifth joint to be coupled to the vehicle structure and a sixth joint coupled to the wheel carrier, the fifth joint and sixth joint defining a second axis, the second axis forming a first angle with the longitudinal axis, the first angle between −45° and +example 45 includes ° example 5 includes the rear wheel suspension of example 1, further including a spring having a force action line inclined towards a rear of the vehicle.

Example 6 includes the rear wheel suspension of example 1, wherein the track transverse control arm includes a seventh joint disposed on the wheel carrier (2), the seventh joint vertically offset from the rotational axis.

Example 7 includes the rear wheel suspension of example 1, wherein the track transverse control arm includes an eighth joint to be coupled to the vehicle structure and a nineth joint coupled to the wheel carrier, the eighth joint and the nineth joint defining a third axis, the third axis forming a second angle with the longitudinal axis, the second angle between −20° and +example 20 includes ° example 8 includes the rear wheel suspension of example 1, wherein the camber transverse control arm is disposed in front of the rotational axis and is disposed at a same vertical position as the longitudinal axis.

Example 9 includes the rear wheel suspension of example 1, further including a stabilizer coupled via a coupling rod to the lower transverse control arm, the coupling rod is connected via an tenth joint to the lower transverse control arm and is adjacent to a fourth axis, the fourth axis defined by the first joint and the second joint.

Example 10 includes the rear wheel suspension of example 1, further including a shock absorber coupled between the wheel carrier and the lower transverse control arm.

Example 11 includes a vehicle including a wheel, a vehicle structure, and a rear wheel suspension including a wheel carrier coupled the wheel, the wheel rotatable about a rotational axis, a lower transverse control arm coupled to the wheel carrier below the rotational axis, the lower transverse control arm including a first joint disposed on a vehicle structure and a second joint disposed on the vehicle structure, the second joint displaced from the first joint along a longitudinal axis, a camber transverse control arm coupled to the wheel carrier above the rotational axis, and a track transverse control arm coupled to the wheel carrier in front of the rotational axis, lower transverse control arm, the camber transverse control arm and the track transverse control arm coupling the wheel carrier to the vehicle structure.

Example 12 includes the vehicle of example 11, wherein the lower transverse control arm is coupled to the wheel carrier via a third joint and a fourth joint, the fourth joint displaced from the third joint along the longitudinal axis.

Example 13 includes the vehicle of example 11, wherein the lower transverse control arm includes an upper shell and a lower shell.

Example 14 includes the vehicle of example 11, wherein the camber transverse control arm includes a fifth joint coupled to the vehicle structure and a sixth joint coupled to the wheel carrier, the fifth joint and sixth joint defining a second axis, the second axis forming a first angle with the longitudinal axis, the first angle between −45° and +example 45 includes ° example 15 includes the vehicle of example 11, wherein a rear wheel suspension further includes a spring having a force action line, the force action line inclined towards a rear of the vehicle.

Example 16 includes the vehicle of example 11, wherein the track transverse control arm includes a seventh joint disposed on the wheel carrier (2), the seventh joint vertically offset from the rotational axis.

Example 17 includes the vehicle of example 11, wherein the track transverse control arm includes an eighth joint coupled to the vehicle structure and a nineth joint coupled to the wheel carrier, the eighth joint and the nineth joint defining a third axis, the third axis forming a second angle with the longitudinal axis, the second angle between −20° and +example 20 includes ° example 18 includes the vehicle of example 11, wherein the camber transverse control arm is disposed in front of the rotational axis and is disposed at a same vertical position as the longitudinal axis.

Example 19 includes the vehicle of example 11, wherein a rear wheel suspension further includes a stabilizer coupled via a coupling rod to the lower transverse control arm, the coupling rod is connected via an tenth joint to the lower transverse control arm and is adjacent to a fourth axis, the fourth axis defined by the first joint and the second joint.

Example 20 includes the vehicle of example 11, wherein a rear wheel suspension further includes a shock absorber coupled between the wheel carrier and the lower transverse control arm.

It is noted that this patent claims priority from German Patent Application Serial Number 102019202910.8, which was filed on Mar. 5, 2019, and is hereby incorporated by reference in its entirety.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. A rear wheel suspension comprising:
a wheel carrier configured to mount a wheel of a vehicle, the wheel rotatable about a rotational axis;
a lower transverse control arm coupled to the wheel carrier below the rotational axis, the lower transverse control arm including a first joint to be disposed on a vehicle structure and a second joint to be disposed on the vehicle structure, the second joint displaced from the first joint along a longitudinal axis;
a camber transverse control arm coupled to the wheel carrier above the rotational axis; and
a track transverse control arm coupled to the wheel carrier in front of the rotational axis, wherein the lower transverse control arm, the camber transverse control arm and the track transverse control arm couple the wheel carrier to the vehicle structure.

2. The rear wheel suspension of claim 1, wherein the lower transverse control arm is coupled to the wheel carrier via a third joint and a fourth joint, the fourth joint displaced from the third joint along the longitudinal axis.

3. The rear wheel suspension of claim 1, wherein the lower transverse control arm includes an upper shell and a lower shell.

4. The rear wheel suspension of claim 1, wherein the camber transverse control arm includes a fifth joint to be coupled to the vehicle structure and a sixth joint coupled to the wheel carrier, the fifth joint and sixth joint defining a second axis, the second axis forming a first angle with the longitudinal axis, the first angle between −45° and +45.°

5. The rear wheel suspension of claim 1, further including a spring having a force action line inclined towards a rear of the vehicle.

6. The rear wheel suspension of claim 1, wherein the track transverse control arm includes a seventh joint disposed on the wheel carrier (2), the seventh joint vertically offset from the rotational axis.

7. The rear wheel suspension of claim 1, wherein the track transverse control arm includes an eighth joint to be coupled to the vehicle structure and a nineth joint coupled to the wheel carrier, the eighth joint and the nineth joint defining a third axis, the third axis forming a second angle with the longitudinal axis, the second angle between −20° and +20.°

8. The rear wheel suspension of claim 1, wherein the camber transverse control arm is disposed in front of the rotational axis and is disposed at a same vertical position as the longitudinal axis.

9. The rear wheel suspension of claim 1, further including a stabilizer coupled via a coupling rod to the lower transverse control arm, the coupling rod is connected via an tenth joint to the lower transverse control arm and is adjacent to a fourth axis, the fourth axis defined by the first joint and the second joint.

10. The rear wheel suspension of claim 1, further including a shock absorber coupled between the wheel carrier and the lower transverse control arm.

11. A vehicle including:
a wheel;
a vehicle structure; and
a rear wheel suspension including:
a wheel carrier coupled the wheel, the wheel rotatable about a rotational axis;
a lower transverse control arm coupled to the wheel carrier below the rotational axis, the lower transverse control arm including a first joint disposed on a vehicle structure and a second joint disposed on the vehicle structure, the second joint displaced from the first joint along a longitudinal axis;
a camber transverse control arm coupled to the wheel carrier above the rotational axis; and
a track transverse control arm coupled to the wheel carrier in front of the rotational axis, lower transverse control arm, the camber transverse control arm and the track transverse control arm coupling the wheel carrier to the vehicle structure.

12. The vehicle of claim 11, wherein the lower transverse control arm is coupled to the wheel carrier via a third joint and a fourth joint, the fourth joint displaced from the third joint along the longitudinal axis.

13. The vehicle of claim 11, wherein the lower transverse control arm includes an upper shell and a lower shell.

14. The vehicle of claim 11, wherein the camber transverse control arm includes a fifth joint coupled to the vehicle structure and a sixth joint coupled to the wheel carrier, the fifth joint and sixth joint defining a second axis, the second axis forming a first angle with the longitudinal axis, the first angle between −45° and +45.°

15. The vehicle of claim 11, wherein a rear wheel suspension further includes a spring having a force action line, the force action line inclined towards a rear of the vehicle.

16. The vehicle of claim 11, wherein the track transverse control arm includes a seventh joint disposed on the wheel carrier (2), the seventh joint vertically offset from the rotational axis.

17. The vehicle of claim 11, wherein the track transverse control arm includes an eighth joint coupled to the vehicle structure and a nineth joint coupled to the wheel carrier, the eighth joint and the nineth joint defining a third axis, the third axis forming a second angle with the longitudinal axis, the second angle between −20° and +20.°

18. The vehicle of claim 11, wherein the camber transverse control arm is disposed in front of the rotational axis and is disposed at a same vertical position as the longitudinal axis.

19. The vehicle of claim 11, wherein a rear wheel suspension further includes a stabilizer coupled via a coupling rod to the lower transverse control arm, the coupling rod is connected via an tenth joint to the lower transverse control arm and is adjacent to a fourth axis, the fourth axis defined by the first joint and the second joint.

20. The vehicle of claim 11, wherein a rear wheel suspension further includes a shock absorber coupled between the wheel carrier and the lower transverse control arm.
